(19) United States
(12) Patent Application Publication
(10) Pub. No.: US 2002/0101519 A1
(43) Pub. Date: Aug. 1, 2002

(54) Automatic generation of information identifying an object in a photographic image

(76) Inventor: Jeffrey S. Myers, Newport Beach, CA (US)

Correspondence Address: FITZPATRICK CELLA HARPER & SCINTO, 30 ROCKEFELLER PLAZA, NEW YORK, NY, 10112, US

(21) Appl. No.: 09/770,295

(22) Filed: Jan. 29, 2001

(51) Int. Cl. H04N 5/225; H04N 9/04; H04N 5/76

(52) U.S. Cl. 348/232; 348/207

(57) ABSTRACT

A method and system for electronically cataloging photographic image data uses a transponder that generates and transmits a unique identification code uniquely identifying the subject of the photographic image to a remote detection unit located within a digital camera. Upon receipt, the unique identification code is verified to correspond with the intended subject of a photographic image, and upon successful verification, the image is recorded. The transmitted unique identification code is encoded in the associated recorded image data, and the data is transferred to a computer-readable storage medium and stored in a database. Once stored, the image can be securely accessed and displayed via a user interface using the associated unique identification code.

### BACKGROUND OF THE INVENTION

1. Field of the Invention

The invention relates to electronically cataloging photographic image data. More particularly, the invention relates to automatic generation of information identifying an object taken in a photographic image.

2. Description of the Related Art

Digital cameras have become increasingly prevalent in business environments, and are replacing film-based cameras. These cameras have allowed users to capture images that are stored as digital image data in the digital camera. In addition, the digital camera generates reference data associated with the image such as location data, time data, exposure data and sound data, and stores this data along with the image. Some of the data can be used to catalog the images once they have been downloaded from the camera, so as to allow access and retrieval of particular image within a stored database of images.

Recently, there have been attempts to catalog images automatically based on the identity of individuals appearing in the image, while avoiding the need to enter such identities manually. One setting where referencing photographic images with particular individuals is needed is where pictures are taken of a large number of people, such as at weddings, parties, or at vacation locations such as resorts or on cruise ships. A system currently in use is able to link individuals with various photographic images in which they appear through the use of a colored sticker placed on the exterior of the individual's clothing. This system comprises photographing a person wearing a sticker with either a traditional film camera or a digital camera. The resulting scanned prints or digital images are uploaded to a database, where they are sorted and stored based on the sticker appearing in the image. A person can access images that they appear in by approaching a kiosk where a camera reads their sticker and a pattern/image recognition technique retrieves any images in the database that contain the same sticker. Images can also be retrieved via a personal access code that is provided to the person at the same time that they are provided a sticker.

Whereas the current system is capable of linking specific images with specific individuals, it has some disadvantages. Under this system, associating an image with a particular individual requires that the pattern/image recognition technique locate the sticker in each photo. In order for this to occur, the sticker must appear in the image. If the sticker were covered, or not visible at the time a photograph was taken, the system would be unable to properly catalog and store the image. In addition, under certain circumstances, placement of the sticker could become an inconvenience to a person. For example, if a person with a sticker attached to the person's shirt for some reason had to put on a coat, the person would have to remove the sticker from the shirt and place it on the coat. When the person no longer needed the coat, the sticker would have to be removed from the coat and placed back on the shirt.

### SUMMARY OF THE INVENTION

The invention addresses the foregoing disadvantages by providing automatic generation of information that identifies an object (such as a person) captured by a digital camera in a photographic image.

Accordingly, the invention is directed to a system and method for electronically referencing photographic images. The system and method include a generator for generating and transmitting a unique identification code, where the unique identification code is unique to the specific object in the image. The generator transmits the unique identification code to a receiver, wherein the receiver is remotely located from the generator. Upon receipt, the unique identification code is verified, and then the image corresponding to the unique identification code is recorded. The unique identification code is encoded in the recorded image data, and then transferred to a computer-readable storage medium, where it is stored in a database. Once transferred, the image data can then be securely accessed from the database and displayed via a user interface.

Generating and transmitting a unique identification code uniquely identifying the subject of a photographic image directly to a digital camera, and encoding the unique identification code in the associated recorded image, eliminates the problems associated with systems currently in use for cataloging images based on the identify of individuals appearing in the image.

This brief summary has been provided so that the nature of the invention may be understood quickly. A more complete understanding of the invention can be obtained by reference to the following detailed description of the preferred embodiment(s) thereof in connection with the attached drawings.

### BRIEF DESCRIPTION OF THE DRAWINGS

FIG. 1 is a drawing illustrating the preferred embodiment of the present invention.

FIG. 2 is a flowchart for describing processing according to the preferred embodiment.

FIG. 3 is a block diagram of the internal architecture of a digital camera used in the present invention.

FIG. 4 is a block diagram depicting the preferred embodiment of storing a unique identification code together with associated image.

FIG. 5 is a block diagram depicting preferred embodiment of the database system in the present invention.

FIG. 6 is a second embodiment of the system in the present invention.

FIGS. 7, 8, 9, and 10 are representational views of the present invention's user interface.

### DETAILED DESCRIPTION OF THE PREFERRED EMBODIMENT

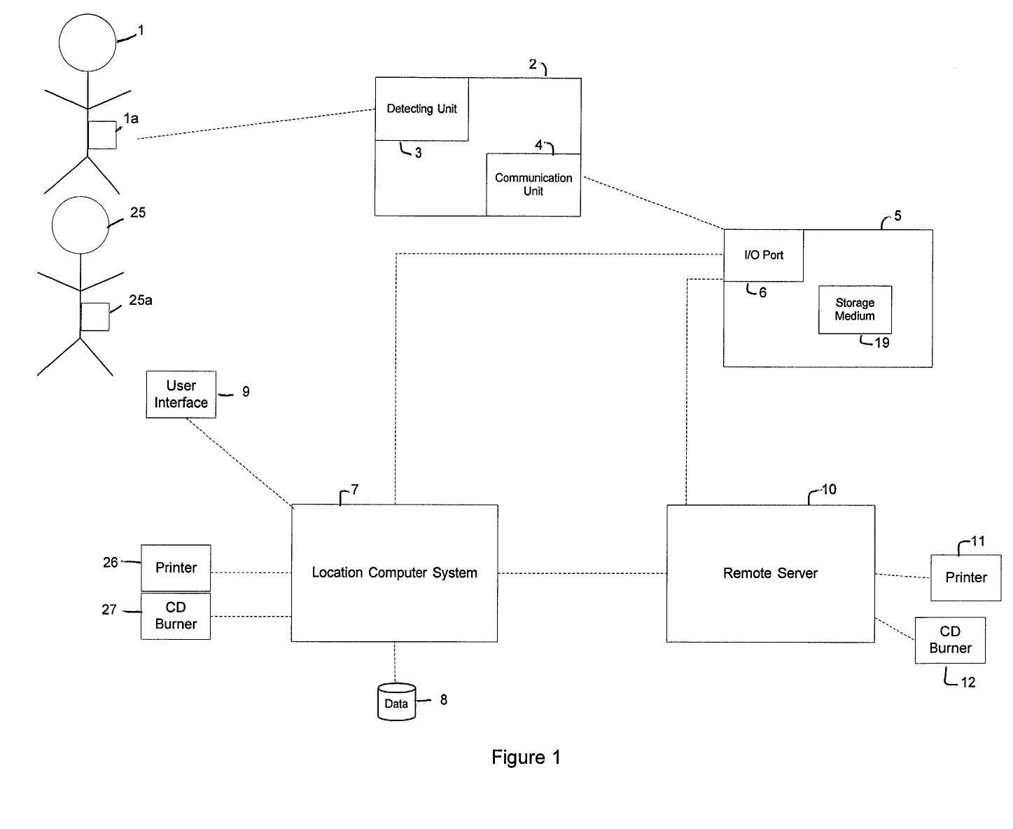

FIG. 1 is a representational view of the preferred embodiment of the present invention. As seen in FIG. 1, generator 1a is associated with an object 1 to be identified in a photographic image, such as a person or individual, or such as a stationary or movable object (hereinafter “the identified object” or “the identified person”). The generator 1a generates and transmits a signal encoding a unique identification code pre-designated to correspond and to identify the identified object. The generator 1a, which is preferably a radio frequency or infrared transponder, may either by a stand-alone item, or can be attached to another item, such as a room key. The unique identification code is unique to the object in possession of the generator 1a, and is preferably assigned at the time the generator 1a is associated with the object, although it can be associated afterwards. For example, when a person goes on a cruise, they are assigned a specific cabin. The cabin number can be used as the unique identification code and is associated with the cabin's occupant at the time the cabin assignment is made. When the person boards the ship, they are provided a cabin key with attached generator 1a, where generator 1a has been programmed with the cabin number. This example is not limited to a cruise ship environment, and is applicable to other situations.

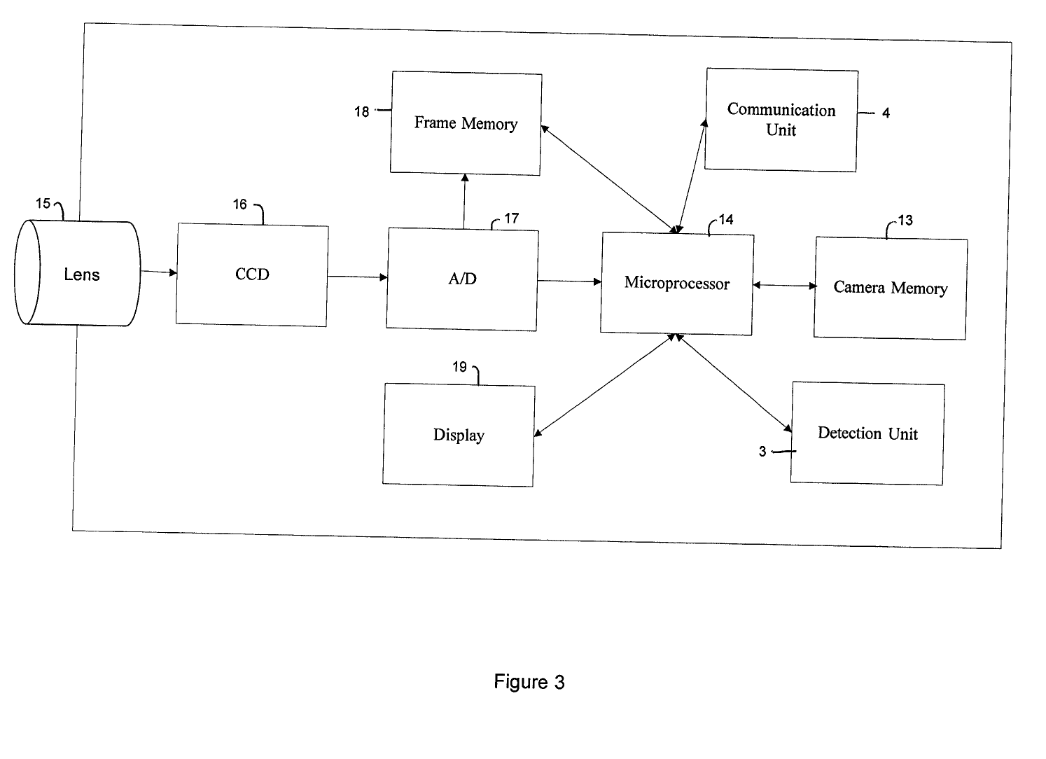

The generator 1a transmits the unique identification code to an associated detection unit 3, which is located in a location remote from the generator la. The detection unit 3 of the present invention is preferably one component of a digital camera 2 which is used to capture an image containing the identified object. As shown in FIG. 3, digital camera 2, includes a camera memory medium 13 that is used for capturing and storing digital pictures and associated data. The pictures are preferably stored in digital camera 2 as camera-formatted data that includes both full-resolution (e.g., 1024×728 pixel) JPEG image file and low-resolution thumbnail (e.g., 60×80 pixel) JPEG image file, in accordance with a camera format defined by digital camera 2. Associated data including one or more sound files, a picture created date, ownership information, and other data can be stored with each picture.

In addition to detection unit 3 and camera memory medium 13, digital camera 2 also includes a microprocessor 14 and a communication unit 4. It should be noted that other architectures for digital cameras can be used in conjunction with the invention and may possess a different and possibly more complex architecture.

Digital camera 2 includes lens 15 for gathering light waves from objects towards which lens is pointed, charge-coupled device 16 for translating the received light waves into analog signals, analog to digital converter 17 for converting the analog signals into digital signals, and frame memory 18 for storing a single picture frame, and a display 19 for display of images and information. It should be understood that a digital camera with the additional feature of a microphone (not shown) may be used in accordance with the invention.

The above elements are controlled by microprocessor 14, which stores a picture from frame memory into (possibly removable) camera memory 13. According to the preferred embodiment of the invention, microprocessor 14 stores a capture picture in camera memory 13 as a full-resolution (e.g., 1024×768 pixel) compressed image file and as a thumbnail (e.g., 60×80 pixel) image file. In the preferred embodiment, microprocessor 14 stores any unique identification codes detected by detecting unit 3 from one or more generators 1a in a manner that associates the unique identification code or codes with the corresponding image file that contains the identified object or objects.

Digital camera 2 can be connected to a computer 5 through a cable or other form of connection via communication unit 4. Communication unit 4 is controlled by microprocessor 14. Although communication unit 4 is preferably a simple serial port, any other method or functionality connecting digital camera 2 to computer 5, such as infrared, USB, or the like, may be used in practicing the invention. Once digital camera 2 is functionally connected to computer 5, the files and data, including the unique identification code, for each picture stored in digital camera 2 are available for download onto computer 5, where they are stored on a computer-readable storage medium 19. According to the invention, this uploading can be performed via a camera driver executing on computer 5 from an application program.

It should be understood that computer 5 as described in the invention could be any type of computer, such as a portable personal computer, a digital assistant, or a desktop personal computer.

After the files and data have been downloaded onto computer 5, the files and data are transferred from computer 5 to a database 8 which preferably is located on a remote computer system 7 via computer's 5 input/output interface port 6. Any method of functionality connecting computer 5 with remote computer system 7, such as a local or wireless network, may be used in practicing the invention.

Once the files and data have been stored in database 8, they can be accessed and displayed via a user interface 9 using the associated unique identification code.

Orders for visual prints of the images are placed using user interface 9 and received by computer system 7. Computer system 7 then transmits the request to a remote server 10. Remote server 10 creates the requested visual prints using standard equipment available in the industry, such as photo printer 11. The resulting prints would then be shipped to the requester using the requestor's personal information stored in database 8. In an alternative embodiment, creation of a compact disc, using standard compact disc burner 12, containing the images can be requested either in place of or in addition to visual prints. In yet another embodiment, instead of transmitting the request for visual prints to remote server 10, computer system 7 creates the requested visual prints using photo printer 26 and compact disc burner 27.

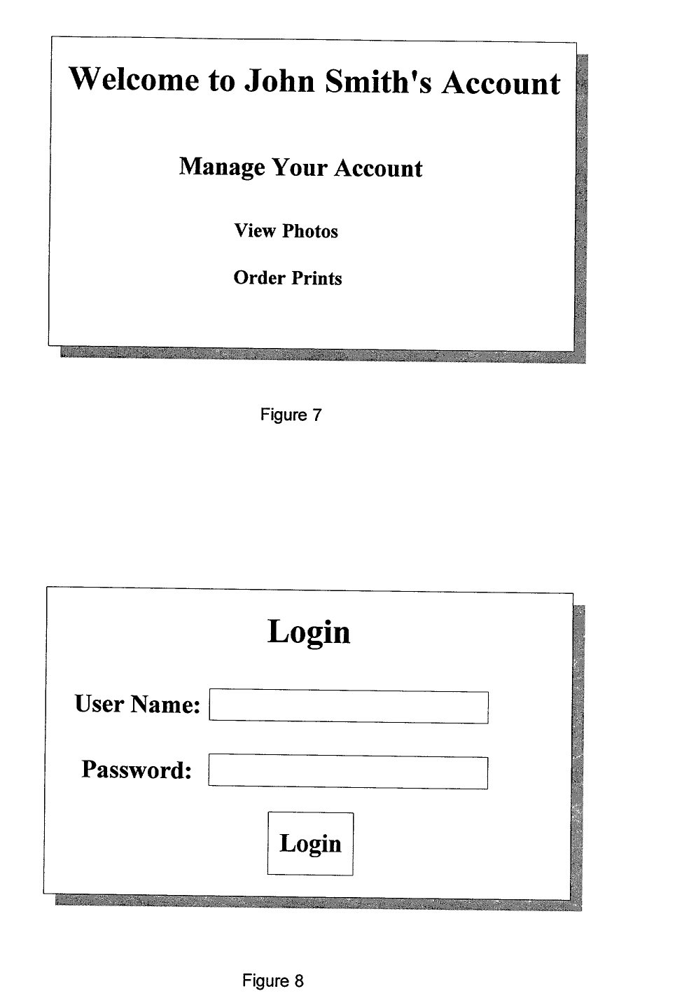

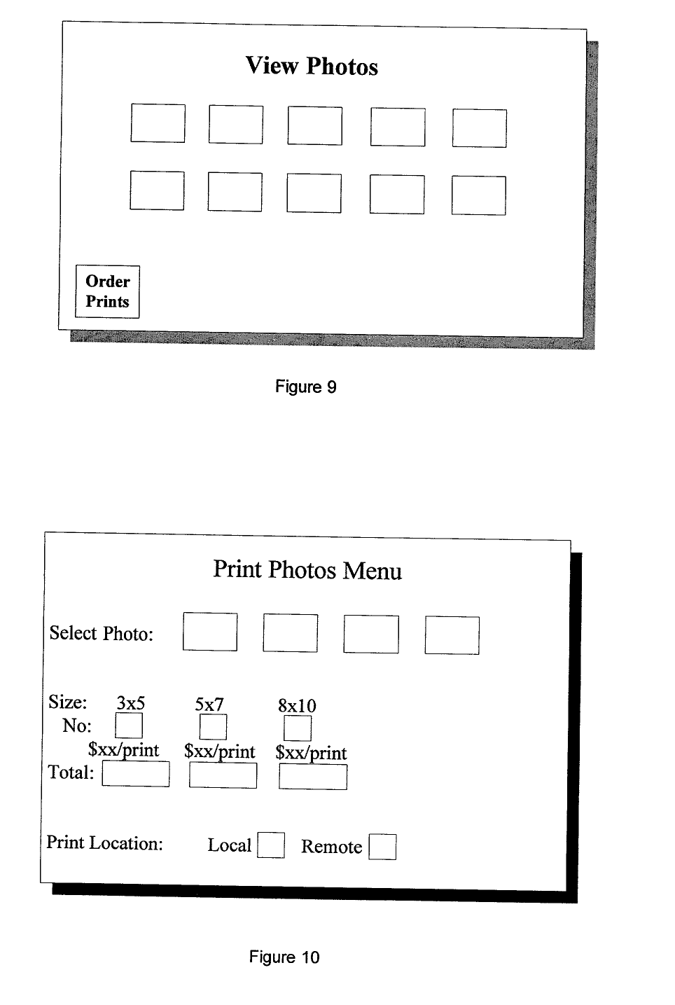

FIGS. 7, 8, 9, and 10 are representational views of the present invention's user interface. FIG. 7 depicts the initial screen and presented to the user upon accessing the system. From this screen, the user is presented with the option of displaying their photographs or ordering their photographs. In order to access either option, the user is prompted to enter a password and an identification number, as depicted in FIG. 8. In the preferred embodiment, the password is the passenger's last name and the identification number is the unique identification code that was assigned to the passenger. If the user chose to display the photographs, after both the password and identification number are entered and validated, the system retrieves all photographs stored on the database associated with the inputted identification number and displays them, as shown in FIG. 9. The user is also given an option to switch to the ordering screen, where the passenger is given the option of ordering prints for a single or multiple photographs, with the order processed as previously described. If the user initially chooses the order option, the user is prompted to enter a password and identification number as previously described. After both the password and identification number are entered and validated, the system retrieves all photographs stored on the database associated with the inputted identification number and provides the user with various ordering options (e.g., size of prints, number of prints), as depicted in FIG. 10.

In another embodiment, computer 5 interfaces with remote server 10 directly, and orders for visual prints and compact discs are made directly from computer 5.

In yet another embodiment, after the files and data have been downloaded from digital camera 2 onto computer 5, computer transmits the unique identification code to remote computer system 7, where the passenger name associated with the transmitted unique identification code is retrieved from database 8 and transmitted to computer 5. Computer 5 then transmits the passenger name back to digital camera 2, where it is displayed for the photographer.

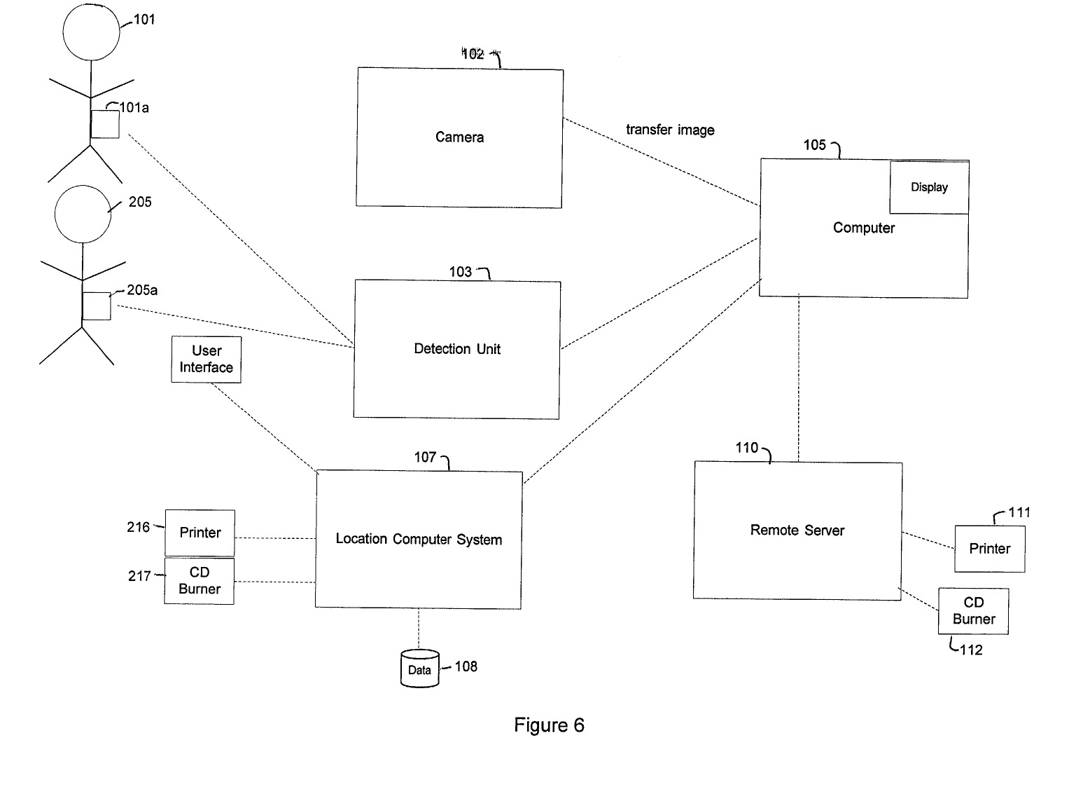

FIG. 6 depicts another embodiment of the present invention, in which reference numbers similar to those in FIG. 1 have been assigned. In this embodiment, detection unit 103 is not a component of camera 102, but is a stand-alone component. Both camera 102 and detection unit 103 are connected to computer 105 via a cable or other form of connection. Computer 105 is connected to the remote computer system 107 via cable or other form of connection. In yet another embodiment, computer 105 is connected to remote server 110. In still another embodiment, computer 105 is connected to both remote computer system 107 and remote server 110.

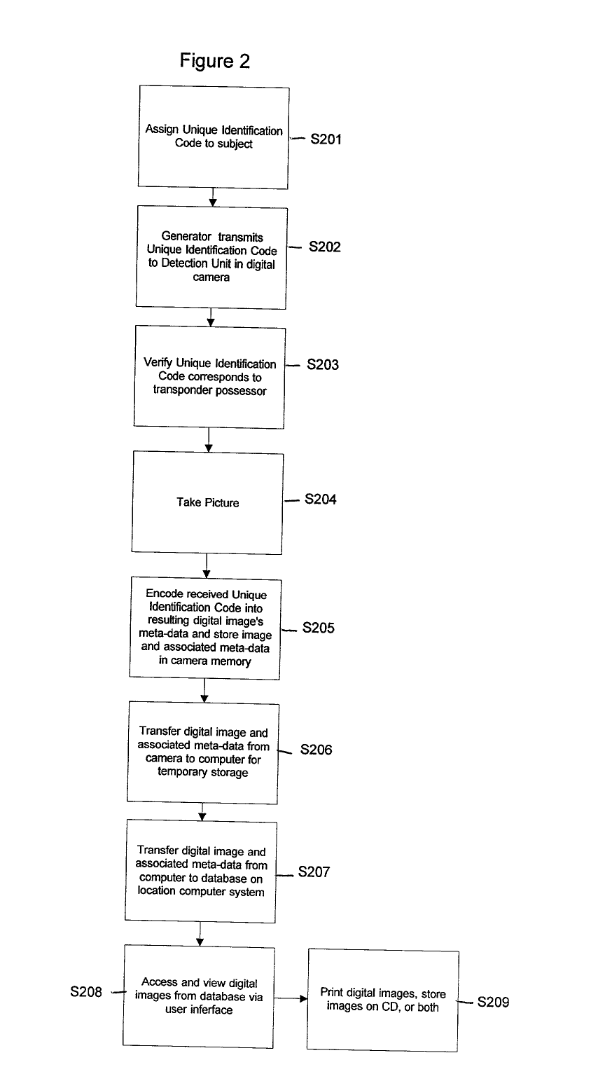

FIG. 2 is a flowchart for describing electronic cataloging of photographic image data according to the invention. As described above, the invention is directed to automatically linking photographic images to the correct corresponding objects in an environment where numerous photographs are taken of a large number of different identified objects. One such environment is a cruise ship. The cruise ship setting will be used as an illustrative example to describe the preferred embodiment of the invention. It should be understood that the invention could be practiced in any number of settings and is not limited to the cruise ship setting.

Briefly, a unique identification code is assigned to a cruise ship passenger, and the passenger is provided a generator that generates and transmits a signal encoding the assigned unique identification code. When the cruise ship's photographer takes the passenger's picture, the passenger's generator transmits the unique identification code to a corresponding detection unit in the photographer's camera. The photographer verifies that the unique identification code corresponds to the passenger, takes a photograph of the passenger, and the received unique identification code is automatically encoded into the resulting digital image. The photographer downloads the image into a host computer for temporary storage, and at some later time, transfers the image into a database located on the ship's computer system. The passenger, and photographer, can then access and display the images from a location remote from the ship's computer system.

In more detail, in step S201, a passenger is assigned a unique identification code. The code could be any sequence of alphanumeric values, but preferably, is the passenger's room number. The generator 1a is programmed with the assigned unique identification code and given to the passenger. Preferably, the generator 1a would be attached to some object the passenger would possess for the duration of the cruise, like a room key.

In step S202, when a cruise ship photographer is set to take a passenger's picture, the passenger's generator 1a transmits the passenger's unique identification code to a detection unit in the photographer's camera.

Step S203 optionally allows verification that the received unique identification code corresponds to the passenger whose picture is about to be taken. Verification can occur in several ways. One method comprises the camera displaying the passenger's name upon receipt of the unique identification code, and the photographer orally verifying the information by asking the passenger's name.

After verification occurs in Step S203 and the picture is taken in Step S204, the received unique identification code is encoded in the resulting image's associated data using the DIG35 standard as further described herein, and the image and data are stored in camera memory medium 13 in step S205.

Once the photographer is ready, in step S206, the image and associated data is transferred from the camera to computer 5 for temporary storage. As described above, the transfer is performed by the camera's 2 communication unit 4, and is accomplished by any method that functionally connects digital camera 2 to computer 5. Once the functional connection is established, the files and data for each picture stored in digital camera 2 are available for upload onto computer 5.

After the files and data for each picture have been transferred to computer 5, in step S 207 the photographer at some later time, transfers the files and data from computer 5 to database 8 located on the cruise ship's computer system 7, the structure of database 8 further described herein.

In step S208, after the files and data for each picture have been downloaded into database 8, they can be accessed and displayed via a user interface 9 using the unique identification code as further described herein. Access using the unique identification code allows for secure viewing of the image. In the preferred embodiment access and display of the files and data is performed from a location remote from where the data and files are stored, such as the passenger's room. It should be noted that any other method of displaying the files and data may be used in accordance with the invention. Finally, in step S209, the images are printed, stored on a compact disc, or both.

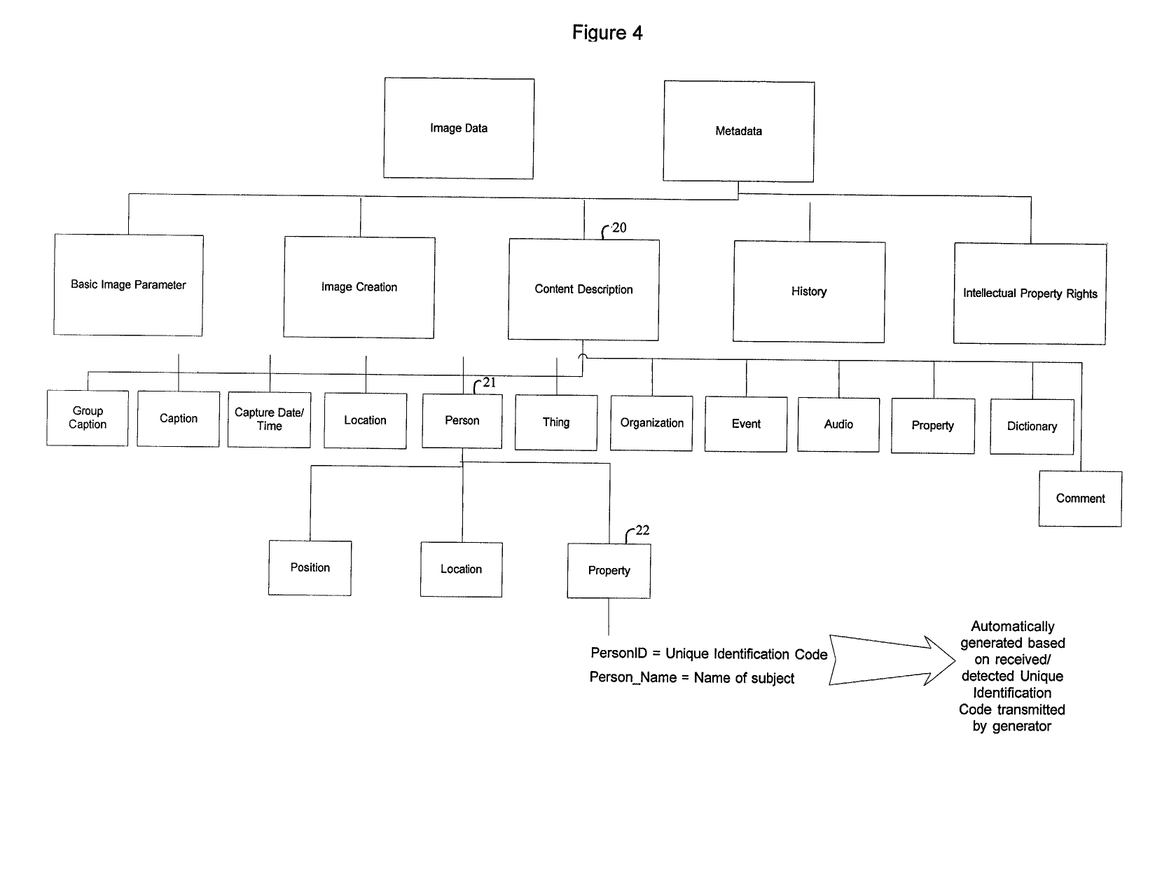

FIG. 4 depicts the preferred embodiment of embedding the unique identification code in the associated image using the DIG35 standard. DIG35 refers to a standard set of metadata for digital images resulting from a broad collaboration of imaging and technology industry participants. As shown in FIG. 4, the DIG35 metadata consists of five logical blocks, where each block defines a unique aspect of the image. One of these unique logical blocks is Content Description 20. As its name indicates, this particular metadata block contains various sections that define the content of an image. In one preferable aspect of the invention, person field 21 is added to content block 21 of the meta-data. The Person 21 description contains sub-fields that can be used to describe the subject or subjects within an image. One sub-field, Property 22, can be used to specifically identify the subject or subjects within an image. It is this sub-field where the passenger's unique identification code is automatically embedded by microprocessor 14 of camera 2.

In another embodiment, the passenger's name, which was transmitted to camera 2 as described in a previous embodiment, is also embedded into the Property 22 sub-field. In yet still another embodiment, multiple objects 1, 25 are present in a single photographic image with each object possessing its own generator 1a, 25a that transmits a unique identification code for each object. In this embodiment, since the maximum size of the Property 22 sub-field is unbounded, all of the various unique identification codes are embedded into the Property 22 sub-field.

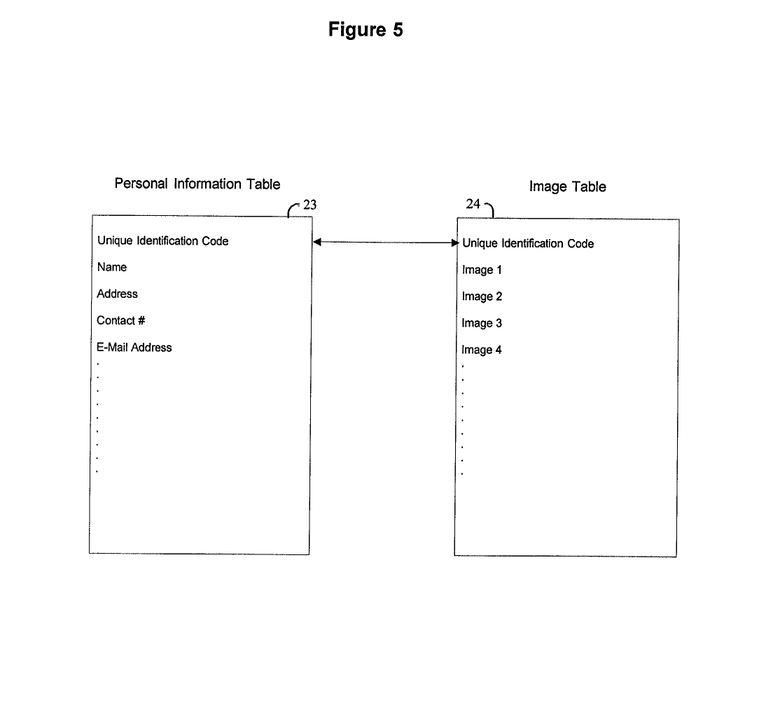

The preferred structure of database 8 is shown in FIG. 5. Image Table 24 contains the images and the images' respective unique identification code downloaded from computer 5. One Image Table 24 is created for each respective unique identification code present in the downloaded Property 22 sub-field. Personal Information Table 23 contains personal information for each cruise ship passenger. The fields of this table include items such as the passenger's name, address, contact number, and electronic mail address. In addition, the passenger's unique identification code is also stored in this table. The unique identification code in Personal Information Table 23 is the same field as the unique identification code in Image Table 24. This common field is used to link the two tables together. This link is what enables passengers to access and display their images via user interface 9.

While the invention is described above with respect to what is currently considered its preferred embodiment, it is to be understood that the invention is not limited to that described above. To the contrary, the invention is intended to cover various modifications and equivalent arrangements within the spirit and scope of the appended claims.

What is claimed is:

1. A method for electronically cataloging an object appearing in a photographic image, comprising:
receiving a unique identification code from a remote generator that generates the unique identification code, the unique identification code being unique to the object in the image;
storing image data for the image in association with the unique identification code;
accessing the stored image data via the unique identification code; and
outputting the image data.

2. A method according to claim 1, wherein the generator is a transponder.

3. A method according to claim 2, wherein the transponder is located on the object in the image.

4. A method according to claim 1, wherein reception of the transmitted unique identification code is via a receiver, wherein the receiver is a component of a camera that captures the image.

5. A method according to claim 4, wherein the receiver receives the unique identification code via a wireless interface.

6. A method according to claim 1, wherein encoding of the unique identification code is accomplished using the DIG35 standard.

7. A method according to claim 1, wherein the image data is stored in a database system on a computer-readable storage medium.

8. A method according to claim 1, further comprising the step of verifying that the unique identification code corresponds to the possessor of the transponder.

9. A method according to claim 1, wherein accessing and outputting the image data is performed from a location remote from the computer-readable storage medium.

10. A method according to claim 10, wherein said accessing is a selective authorized access, wherein the unique identification code associated with the image allows only authorized access to the image.

11. A method according to claim 1, wherein said outputting step comprises outputting by display.

12. A method according to claim 1, wherein said outputting step comprises outputting by print.

13. A method according to claim 12, wherein the image is printed at a remote location from the computer-readable storage medium.

14. A method according to claim 13, wherein the image is printed in a variety of sizes and formats.

15. A method according to claim 1, wherein said outputting step comprises outputting by storage onto a removable computer readable memory medium.

16. A method according to claim 1, wherein the image contains multiple objects.

17. A method according to claim 16, wherein each object has a unique identification code.

18. A system for electronically cataloging an object appearing in a photographic image, comprising:
a generator that generates and transmits a unique identification code, the unique identification code being unique to the object in the image;
a storage device that stores image data for the image in association with the unique identification code;
access means for accessing the stored image data via the unique identification code; and
output means for outputting the image data.

19. A system according to claim 18, wherein the generator is a transponder.

20. A system according to claim 19, wherein the transponder is located on the object in the image.

21. A system according to claim 18, wherein the receiver is a component of a camera that captures the image.

22. A system according to claim 21, wherein the receiver receives the unique identification code via a wireless interface.

23. A system according to claim 18, wherein encoding of the unique identification code is accomplished using the DIG35 standard.

24. A system according to claim 18, wherein the image data is stored in a database system on a computer-readable storage medium.

25. A system according to claim 18, further comprising verification means for verifying that the unique identification code corresponds to the possessor of the transponder.

26. A system according to claim 18, wherein accessing and outputting the image data is performed from a location remote from the computer-readable storage medium.

27. A system according to claim 26, wherein said accessing is a selective authorized access, wherein the unique identification code associated with the image allows only authorized access to the image.

28. A system according to claim 18, wherein said outputting means outputs by display.

29. A system according to claim 18, wherein said outputting means outputs by print.

30. A system according to claim 29, wherein the image is printed at a remote location from the computer-readable storage medium.

31. A system according to claim 29, wherein the image is printed in a variety of sizes and formats.

32. A system according to claim 18, wherein said outputting means outputs by storage onto a removable computer readable memory medium.

33. A system according to claim 18, wherein the image contains multiple objects.

34. A system according to claim 33, wherein each object has a unique identification code.

35. An apparatus for electronically cataloging an object appearing in a photographic image, comprising:
a receiver for receiving a unique identification code from a remote generator that generates the unique identification code, the unique identification code being unique to the object in the image;
a memory for storing executable process steps;
a processor to execute said process steps stored in said memory;
wherein said process steps include (a) capturing image data for the image associated with the unique identification code, (b) storing the unique identification code in association with the captured image data, and (c) transferring the stored recorded image data with the stored unique identification code to a computer-readable storage medium.

36. An apparatus according to claim 35, wherein the receiver receives the unique identification code via a wireless interface.

37. An apparatus according to claim 35, wherein storing of the unique identification code is accomplished using the DIG35 standard.

38. An apparatus according to claim 35, wherein transfer of the image to a computer-readable storage medium is performed via a wired or wireless interface.

39. An apparatus according to claim 35, wherein the image contains multiple objects.

40. An apparatus according to claim 39, wherein each object has a unique identification code.

41. A method for automatically storing information identifying an object in an image, comprising the steps of:
receiving a unique identification code from a remote generator that generates the unique identification code, the unique identification code being unique to the object in the image;
capturing image data for the image;
generating meta-data for the image data, the meta-data including the unique identification code; and
storing the meta-data together with the captured image data into a storage medium.

42. A method according to claim 41, wherein the meta-data is stored in a standard format of data for digital photographic image.

43. A method according to claim 42, wherein the meta-data is stored in a DIG35 standard format of data.

44. A method according to claim 41, wherein said generating step includes the step of retrieving information corresponding to the unique identification code.

45. A method according to claim 44, further comprising the step of verifying the retrieved information.

46. A method according to claim 41, further comprising the step of accessing and displaying the image stored in the storage medium via a user interface.

47. A method according to claim 41, wherein the image contains multiple objects.

48. A method according to claim 47, wherein each object has a unique identification code.

49. A system for automatic generation of information which identifies an object in an image, comprising:
receiving means for receiving a unique identification code from a remote generator that generates the unique identification code, the unique identification code being unique to the object in the image;
capturing means for capturing image data for the image;
generating means for generating meta-data for the image data, the meta-data including the unique identification code; and
storing means for storing the meta-data together with the captured image data into a storage medium.

50. A system according to claim 49, wherein the meta-data is stored in a standard format of data for digital photographic image.

51. A system according to claim 49, wherein the meta-data is stored in a DIG35 standard format of data.

52. A method according to claim 51, wherein said generating step includes the step of retrieving information corresponding to the unique identification code.

53. A system according to claim 52, further comprising verification means for verifying the retrieved information.

54. A system according to claim 49, further comprising accessing means and displaying means for accessing and displaying, respectively, the image data stored in the storage medium via a user interface.

55. A system according to claim 49, wherein the image contains multiple objects.

56. A system according to claim 55, wherein each object has a unique identification code.
